(19) United States
(12) Patent Application Publication
(10) Pub. No.: US 2007/0241251 A1
(43) Pub. Date: Oct. 18, 2007

(54) BOTTOM MOUNTED STAIR ROD BRACKET

(75) Inventor: Aboolhassan Zoroufy, Madison, WI (US)

Correspondence Address: MICHAEL BEST & FRIEDRICH LLP, ONE SOUTH PINCKNEY STREET, P O BOX 1806, MADISON, WI, 53701, US

(73) Assignee: STAIR HOLD, INC., Middleton, WI (US)

(21) Appl. No.: 11/693,359

(22) Filed: Mar. 29, 2007

Related U.S. Application Data
(60) Provisional application No. 60/744,092, filed on Mar. 31, 2006.

(51) Int. Cl. F16B 1/00

(52) U.S. Cl. 248/251; 248/71

(57) ABSTRACT

The invention provides a stair rod bracket designed to receive a stair rod that secures a carpet to stairs. The bracket comprises a bottom plate having an aperture that suitably can be designed to receive a fastener such as a screw or a nail. A sidewall completely surrounds the bottom plate creating an opening. The sidewall has an exterior, an interior, a bottom end, which is attached or integral to the bottom plate, and an upper end. The sidewall also comprises a stair rod receiving portion. In one embodiment, this stair rod receiving portion can be an aperture in the sidewall designed to receive the end of a stair rod. In another embodiment the stair rod receiving portion can be a notch that opens at the upper end of the sidewall, and has bottom section which the stair rod rests on.

### CROSS-REFERENCE TO RELATED APPLICATIONS

This application claims the benefit of U.S. Provisional Patent Application No. 60/744,092 filed Mar. 31, 2006, which is incorporated herein by reference.

### BACKGROUND OF THE INVENTION

The present invention relates generally to stair rod brackets and to stair rods. Carpet runners or other floor coverings are releasably affixed to stairs using stair rod sets. Many stair rod sets sold today are used as a decorative accent to the stairs and carpet runners. The stair rod set serves a decorative function as well as a useful function in preventing slippage of the carpet runner on the stairs of a staircase. A staircase typically has a plurality of steps. Each step has a riser and a tread. The stair rod set typically includes a pair of brackets with each bracket fastened to the step of a staircase. The brackets are spaced from the edges of the carpet runner and fastened at opposite sides of the step. Stair brackets frequently have a top portion and a bottom portion. Often, the bottom portion is fastened to the riser and the tread of the step of the staircase. A rod extends over the carpet runner and is held between and by the pair of brackets. A pair of finials may be used in conjunction with the stair rod and pair of brackets with one finial attached to each bracket. The present invention allows for a number of decorative or lighting inserts to be used with stair rods and finials.

### SUMMARY OF THE INVENTION

The present invention provides a stair rod bracket designed to receive a stair rod that secures a carpet to stairs. The bracket comprises a bottom plate having an aperture that suitably can be designed to receive a fastener such as a screw or a nail. A sidewall completely surrounds the bottom plate creating an opening. The sidewall has an exterior, an interior, a bottom end, which is attached or integral to the bottom plate, and an upper end. Suitably, the sidewall provides a circular enclosure around a circularly shaped bottom plate, however, the bottom plate and surrounding sidewall can be of any geometry. The sidewall also comprises a stair rod receiving portion. In one embodiment, this stair rod receiving portion can be an aperture in the sidewall designed to receive the end of a stair rod. Another embodiment can be a notch that opens at the upper end of the sidewall, and has a bottom section which the stair rod rests on. The sidewall can also have a finial receiving aperture that can receive a finial. This aperture may be a threaded aperture designed to receive a “male” threaded post attached to a finial. In another embodiment the finial can be attached or integral to the sidewall by other connection means such as welding or gluing.

The bracket can comprise a stabilizing portion that is attached, or integral to, the sidewall. The stabilizing portion can be any structure that extends from the sidewall such that when the bracket is installed on the tread of a stair, the stabilizing portion is in contact with the rise of the stair. The stabilizing portion can thusly brace the stair rod bracket from turning. Suitably, the stabilizing portion can be in the form of a block or tab extending from the sidewall, but can in other embodiments be any other desired structure, as long as the portion is of a sturdy structure and can make contact with the rise of a stair when the stair rod bracket is mounted to the tread of a stair.

Suitably, the stair rod bracket can also contain a cap that can attach to the upper end of the sidewall, thus enclosing the opening of the bracket. The cap is suitably able to be attached and removed from the upper end of the sidewall with ease. Any known attachment method can be used including a “screw top” arrangement with threads being positioned on the cap and on the sidewall, a “snap fit” arrangement with tabs being found on the cap and the sidewall.

### BRIEF DESCRIPTION OF THE DRAWINGS

FIG. 1 shows an expanded perspective view of one embodiment of the stair rod bracket and the stair rod;

FIG. 2 shows a perspective view of one embodiment of the stair rod bracket receiving the stair rod;

FIG. 3 shows a perspective view of one embodiment of the stair rod bracket having a finial;

FIG. 4 shows a top view of one embodiment of the stair rod bracket having a stabilizing portion;

FIG. 5 shows a perspective view of another embodiment of the stair rod bracket receiving the stair rod;

FIG. 6 shows a front view of one embodiment of the stair rod bracket and cap;

FIG. 7 shows a perspective view of a pair of stair rod brackets and a stair rod securing a carpet to a stair case.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including”, “having” and “comprising” and variations thereof herein is meant to encompass the items listed thereafter and equivalents thereof as well as additional items and equivalents thereof. The use of the term “attached” is meant that the elements listed as attached to each other are either secured to each other, affixed to each other, attached to each other, or integral to each other (i.e., present in the same piece).

### DETAILED DESCRIPTION OF THE INVENTION

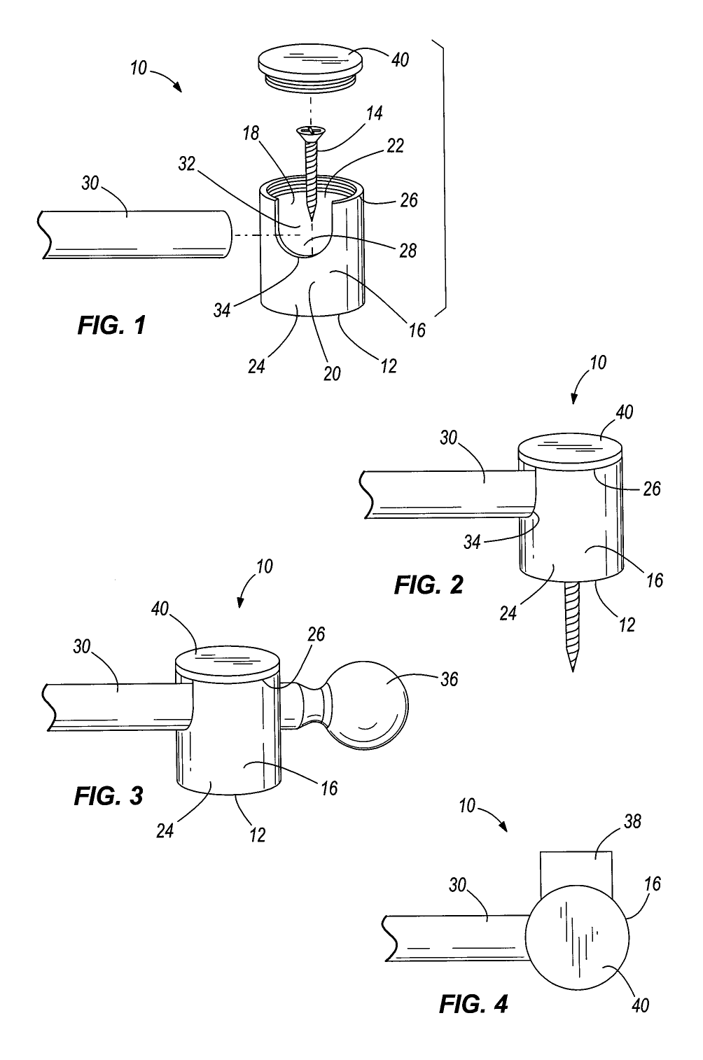

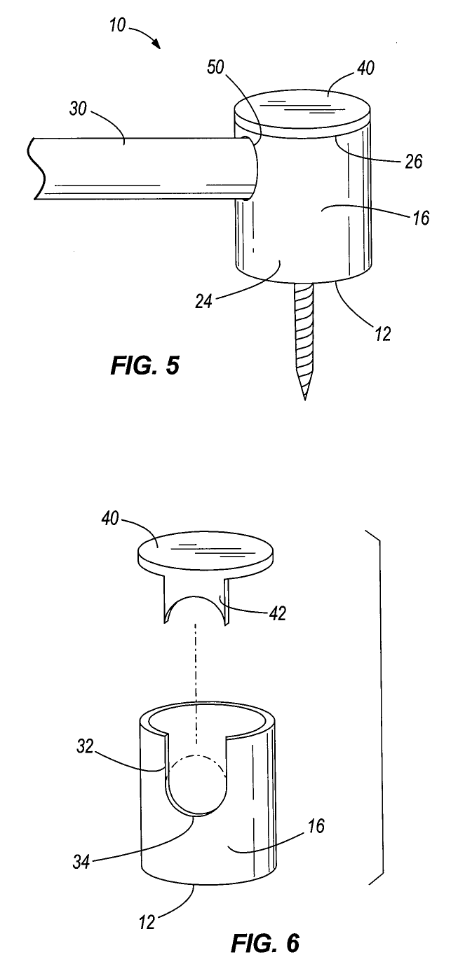

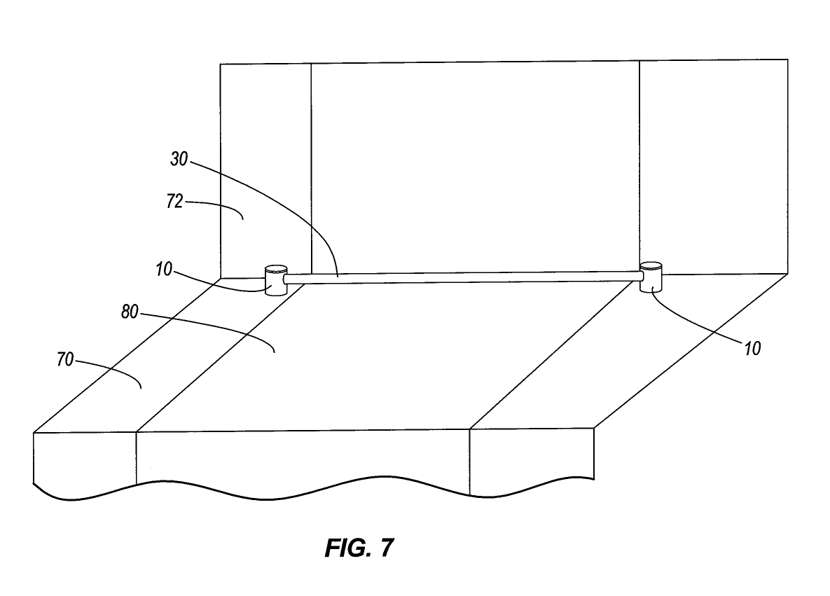

The present invention provides a stair rod bracket 10 designed to receive a stair rod 30 that secures a carpet 80 to stairs. The invention is best shown in FIGS. 1-7.

The bracket 10 comprises a bottom plate 12 having an aperture that suitably can be designed to receive a fastener 14 such as a screw or a nail. A sidewall 16 completely surrounds the bottom plate 12 creating an opening 18. The sidewall 16 has an exterior 20, an interior 22, a bottom end 24, which is attached or integral to the bottom plate 12, and an upper end 26. Suitably, the sidewall 16 provides a circular enclosure around a circularly shaped bottom plate 12, however, the bottom plate 12 and surrounding sidewall 16 can be of any geometry. The sidewall 16 also comprises a stair rod receiving portion 28. In one embodiment, this stair rod receiving portion 28 can be an aperture 50 in the sidewall 16 designed to receive the end of a stair rod 30. In another embodiment, the stair rod receiving portion 28 can be a notch 32 that opens at the upper end 26 of the sidewall 16, and has a bottom section 34 which the stair rod 30 rests on. The sidewall 16 can also have a finial receiving aperture that can receive a finial 36. This aperture may be a threaded aperture designed to receive a “male” threaded post attached to a finial 36. In another embodiment, the finial 36 can be attached or integral to the sidewall 16 by other connection means such as welding or gluing.

The bracket 10 can comprise a stabilizing portion 38 that is attached, or integral to, the sidewall 16. The stabilizing portion 38 can be any structure that extends from the sidewall 16 such that when the bracket 10 is installed on the tread 70 of a stair, the stabilizing portion 38 is in contact with the rise 72 of the stair. The stabilizing portion 38 can thusly brace the stair rod bracket 10 from turning. Suitably, the stabilizing portion 38 can be in the form of a block or tab extending from the sidewall 16, but can, in other embodiments, be any other desired structure, as long as the stabilizing portion 38 is of a sturdy structure and can make contact with the rise 72 of a stair when the stair rod bracket 10 is mounted to the tread 70 of a stair.

Suitably, the stair rod bracket 10 can also contain a cap 40 that can attach to the upper end 26 of the sidewall 16, thus enclosing the opening 18 of the bracket 10. The cap 40 is suitably able to be attached to and removed from the sidewall 16 with ease. Any known attachment method can be used including a “screw top” arrangement with threads being positioned on the cap 40 and on the sidewall 16, a “snap fit” arrangement with tabs being found on the cap 40 and the sidewall 16. In one embodiment, the cap 40 can have a notch insert section 42 that is received by the notch 32 of the sidewall.

The bottom plate and sidewalls can be made form any sturdy material, suitable metal. The cap can also be made from any sturdy material, including metal or plastic.

The sidewalls, cap and stabilizing portion can have exterior ornamentation that adds to the aesthetic appearance of the bracket. In one embodiment, the invention includes a stair rod bracket kit having caps bearing different ornamentation on the exterior surface of the caps. In one embodiment, the caps can be comprised of a transparent material, and the opening of the stair rod bracket can contain a battery and an illumination device, such as a light emitting diode, that cause the cap to be illuminated from below when situated on the stair rod.

While the present invention has now been described and exemplified with some specificity, those skilled in the art will appreciate the various modifications, including variations, additions, and omissions that may be made in what has been described. Accordingly, it is intended that these modifications also be encompassed by the present invention and that the scope of the present invention be limited solely by the broadest interpretation that lawfully can be accorded the appended claims.

1. A stair rod bracket comprising:
a bottom plate having an aperture designed to receive a fastener; and
a sidewall completely surrounding the bottom plate creating an opening, wherein the sidewall has an exterior, an interior, a bottom end attached to the bottom plate, and an upper end; and a stair rod receiving portion.

2. The stair rod bracket of claim 1, wherein the bottom plate and the sidewall are both circular such that the sidewall provides a circular enclosure around the bottom plate.

3. The stair rod bracket of claim 1, wherein the stair rod receiving portion is an aperture in the sidewall designed to receive an end of a stair rod.

4. The stair rod bracket of claim 1, wherein the stair rod receiving portion is a notch; wherein the notch opens at the upper end of the sidewall and the notch has a bottom section on which the stair rod rests.

5. The stair rod bracket of claim 1, wherein the sidewall further comprises a finial receiving aperture that can receive a finial.

6. The stair rod bracket of claim 1, further comprising a stabilizing portion attached to the sidewall wherein the stabilizing portion contacts a rise of a stair when the bracket is installed on a tread of a stair.

7. The stair rod bracket of claim 1, further comprising a cap, wherein the cap attaches to the upper end of the sidewall.

8. The stair rod bracket of claim 7, wherein the cap is removably attached to the sidewall.

9. The stair rod bracket of claim 8, wherein the cap is attached to the sidewall by a screw top arrangement.

10. The stair rod bracket of claim 8, wherein the cap is attached to the sidewall by a snap fit arrangement.

11. The stair rod bracket of claim 8, wherein the cap is transparent.

12. The stair rod bracket of claim 11, wherein the opening contains an illumination device.

13. The stair rod bracket of claim 7, wherein the cap has a notch insert section.
